(19) United States
(12) Patent Application Publication
(10) Pub. No.: US 2008/0075282 A1
(43) Pub. Date: Mar. 27, 2008

(54) Data recording device, and data management method

(75) Inventors: Yoshiju Watanabe, Kanagawa (JP); Toshio Kakihara, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/894,834

(22) Filed: Aug. 21, 2007

(30) Foreign Application Priority Data
Aug. 22, 2006 (JP) 2006-224846

(51) Int. Cl. H04L 9/00

(52) U.S. Cl. 380/44

(57) ABSTRACT

Embodiments in accordance with the present invention provide a data recording device that is capable of easily managing, on a user basis, data key used for data encryption, and to provide a data management method thereof. According to one embodiment, a data encryption/decryption circuit performs the steps of: encrypting write data inputted from the host side, and then outputting the encrypted write data to the magnetic disk side; and decrypting read data inputted from the magnetic disk side, and then outputting the decrypted read data to the host side. A data-key management circuit manages a data key used to operate the data encryption/decryption circuit.

### CROSS-REFERENCE TO RELATED APPLICATION

The instant nonprovisional patent application claims priority to Japanese Patent Application No. 2006-224846 filed Aug. 22, 2006 and which is incorporated by reference in its entirety herein for all purposes.

### BACKGROUND OF THE INVENTION

In order to ensure the security of data recording devices such as magnetic disk drives, there are provided various techniques for protecting data on a recording medium from accesses by third parties. For example, a conventional user authentication function is used for permitting only a user(s) who is authenticated by a password(s) to access data so as to prevent the data from being accessed by third parties.

In addition, as a more effective techniques, there is a technique for encrypting data to be written to a recording medium as disclosed in Japanese Patent Publication No. 2004-201038 (“patent document 1”). According to this technique, at the time of writing of data, the data is encrypted before the data is written to a recording medium; and at the time of reading of the data, the data is decrypted. As a result, the data is protected.

However, if the data recording device is used by a plurality of users, a key used to encrypt data (hereinafter referred to as a “data key”) must be distributed to many users, which causes a security problem. Moreover, for example, if a data key is changed, the redistribution of the data key is a troublesome task, and there is a possibility that users who has used the device for a long time and do not know of the change will suddenly not be able to access data.

### BRIEF SUMMARY OF THE INVENTION

An object in accordance with embodiments of the present invention is to provide a data recording device that is capable of easily managing, on a user basis, data key used for data encryption, and to provide a data management method thereof. According to the particular embodiment disclosed in FIG. 3, a data encryption/decryption circuit performs the steps of: encrypting write data inputted from the host side, and then outputting the encrypted write data to the magnetic disk side; and decrypting read data inputted from the magnetic disk side, and then outputting the decrypted read data to the host side. A data-key management circuit manages a data key used to operate the data encryption/decryption circuit.

### BRIEF DESCRIPTION OF THE DRAWINGS

FIG. 1 is a block diagram illustrating, as an example, a configuration of a data recording device;

FIG. 2 is a block diagram illustrating a main part of FIG. 1;

FIG. 3 is a block diagram illustrating a main part of FIG. 2;

FIG. 4 is a diagram illustrating the operation of storing a user key;

FIG. 5 is a diagram illustrating the operation of encrypting a data key;

FIG. 6 is a diagram illustrating the operation of decrypting a data key; and

FIG. 7 is a diagram illustrating the operation of encrypting a changed data key.

### DETAILED DESCRIPTION OF THE INVENTION

Embodiments in accordance with the present invention relate to a data recording device that is capable of encrypting data to be written to a recording medium, and decrypting data read out from the recording medium, and relates to a data management method thereof.

Embodiments in accordance with the present invention were devised taking the above-described problems into consideration. One of the objects of embodiments of the present invention is to provide a data recording device that is capable of easily managing, on a user basis, a data key used for data encryption, and a data management method thereof.

In order to achieve the above-described objects, according to one aspect of the present invention, there is provided a data recording device comprising: a data encryption/decryption unit for, when a data key is inputted, performing at least one of encryption of data to be written to a recording medium, and decryption of data read out from the recording medium; and a data key decryption unit for, when a decryption key corresponding to one of a plurality of encryption keys is inputted by use of the decryption key, an encrypted data key that is encrypted by use of the one of the plurality of encryption keys, the encrypted data key being one of a plurality of encrypted data keys that have been created by encrypting the data key by use of the plurality of encryption keys respectively, each of which is specific to each user, and then for outputting the data key to the data encryption/decryption unit.

In addition, embodiments according to the present invention further comprise a data key storage unit for storing a plurality of encrypted data keys.

Embodiments according to the present invention further comprise a data key encryption unit for creating a plurality of encrypted data keys by encrypting a data key by use of a plurality of encryption keys, each of which is specific to each user.

Embodiments according to the present invention further comprise a user key storage unit for storing a plurality of encryption keys, wherein the data key encryption unit creates a plurality of encrypted data keys by encrypting a data key by use of a plurality of encryption keys, the plurality of encryption keys being stored in the user key storage unit.

Embodiments according to the present invention further comprise a user key storage unit for storing the plurality of encryption keys, wherein if the data key applied to the data encryption/decryption unit is changed to a new data key, the data key encryption unit newly creates a plurality of encrypted data key by encrypting the new data key by use of the plurality of encryption keys, the plurality of encryption keys being stored in the user key storage unit.

Embodiments according to the present invention further comprise a data-key input state holding unit for holding an input state of the data key for the data encryption/decryption circuit.

According to another aspect of the present invention, there is provided a data management method comprising: a data key encryption step for creating a plurality of encrypted data keys by encrypting a data key by use of a plurality of encryption keys respectively, each of which is specific to each user, said data key being used to perform at least one of encryption of data to be written to a recording medium, and decryption of data read out from the recording medium; a data key decryption step for, when a decryption key corresponding to one of the plurality of encryption keys is inputted by use of the decryption key, the encrypted data key that is encrypted the data key by use of the one of the plurality of encryption keys, the encrypted data key being one of the plurality of encrypted data keys; and data encryption/decryption step for, on the basis of the data key that is decrypted, performing at least one of encryption of data to be written to the recording medium, and decryption of data read out from the recording medium.

According to embodiments of the present invention, it is possible to easily manage data keys on a user basis.

Embodiments of the present invention will be described with reference to the accompanying drawings. In the description below, a magnetic disk drive is described taking as an example of a data recording device. However, the present invention is not limited to this example. The present invention can also be applied to other data recording devices such as optical disk drives, and memory units formed of semiconductors.

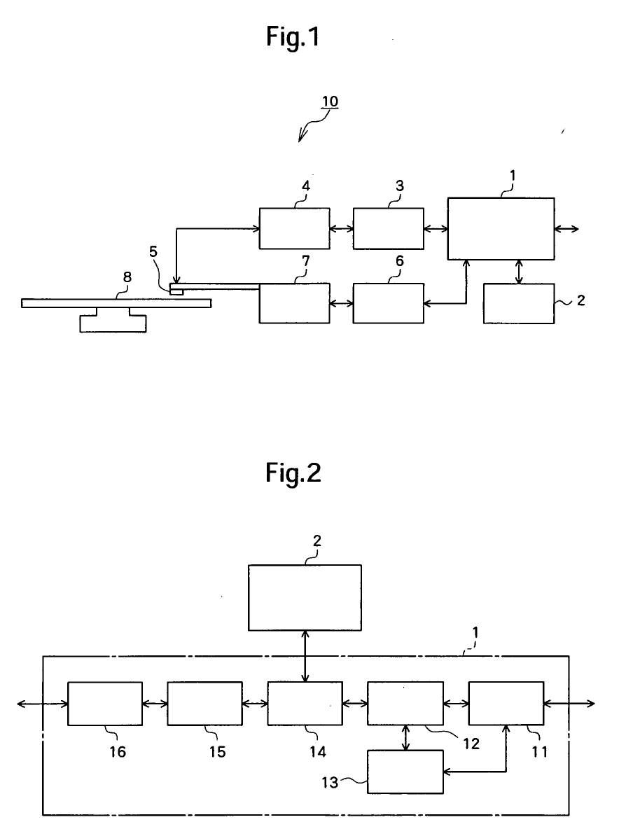

FIG. 1 is a block diagram illustrating, as an example, how a data recording device 10 is configured as a magnetic disk drive. The data recording device 10 includes a MPU/HDC (microprocessing unit/hard disk controller) 1, a memory 2, a R/W channel (read/write channel) 3, a head amplifier 4, a magnetic head 5, a driver 6, a voice coil motor 7, and a magnetic disk 8 that is used as a recording medium.

The MPU/HDC 1 controls the data recording device 10 as a whole, and carries out, for example, the interface control of interfacing with an external host.

The memory 2 includes: a ROM for storing a program and data, which are required for the operation of the MPU/HDC 1; and a RAM that operates as a working memory of the MPU/HDC 1. In addition, the memory 2 is used as a buffer memory for storing data to be written/read to/from the magnetic disk 8.

At the time of writing of data, when a write signal is inputted from the MPU/HDC 1, the R/W channel 3 code-modulates the write signal, and then outputs the code-modulated signal to the head amplifier 4. In addition, at the time of reading of data, when a read signal is inputted from the head amplifier 4, the R/W channel 3 code-demodulates the read signal, and then outputs the code-modulated signal to the MPU/HDC 1.

At the time of writing of data, when a write signal is inputted from the R/W channel 3, the head amplifier 4 amplifies the write signal, and then outputs the amplified signal to the magnetic head 5. In addition, at the time of reading of data, when a read signal is inputted from the magnetic head 5, the head amplifier 4 amplifies the read signal, and then outputs the amplified signal to the R/W channel 3.

At the time of writing of data, when a write signal is inputted from the head amplifier 4, the magnetic head 5 magnetically writes the data to the magnetic disk 8. In addition, at the time of reading of data, the magnetic head 5 reads out the data from the magnetic disk 8 to output the data to the head amplifier 4.

When a control signal is inputted from the MPU/HDC 1, the driver 6 drives the voice coil motor 7 to move the magnetic head 5 over the magnetic disk 8.

FIG. 2 is a block diagram illustrating, as an example, a configuration of the MPU/HDC 1 included in the data recording device 10. The MPU/HDC 1 includes a host interface 11, a data encryption/decryption circuit (data encryption/decryption unit) 12, a data-key management circuit 13, a memory manager 14, an ECC circuit 15, and a disk interface 16. These components operate under the control of the MPU (microprocessing unit), which is not illustrated.

The host interface 11 functions as an interface with the external host.

The data encryption/decryption circuit 12 performs the operations for: encrypting write data, which is inputted from the host interface 11, to output the encrypted write data to the memory manager 14; and decrypting read data, which is inputted from the memory manager 14, to output the decrypted read data to the host interface 11. In addition, the data-key management circuit 13 manages a data key used to operate this data encryption/decryption circuit 12. The detailed configuration thereof will be described later.

The memory manager 14 temporarily stores write data and read data in the memory 2 (buffer memory), the write and read data being transferred between the data encryption/decryption circuit 12 and the ECC circuit 15.

The ECC circuit 15 performs the operations for: adding an error detection code (an ECC code and a CRC code) to write data inputted from the memory manager 14 so as to correct or inspect an error occurring in data, which is transmitted through a path from the MPU/HDC 1 to the magnetic head 5, and in data to be written/read to/from the magnetic disk 8, and then outputting the write data to the disk interface 16; and analyzing an error detection code, which is added to read data inputted from the disk interface 16, so as to correct or inspect an error, and then outputting the read data to the memory manager 14.

An ECC (Error Correcting Code) code and a CRC (Cyclic Redundancy Check) code are used as error detection codes. An error which has occurred in data can be detected and corrected by use of the ECC code. By use of the CRC code, it is possible to detect an error that has occurred in data. The CRC code is used to prevent the error from being erroneously corrected by use of the ECC code.

When write data is inputted from the ECC circuit 15, the disk interface 16 outputs the write data to the R/W channel 3, and instructs the magnetic head 5 to write the data. Moreover, when a data string of read data which is read out by the magnetic head 5 is inputted from the R/W channel 3, the disk interface 16 outputs the data string to the ECC circuit 15.

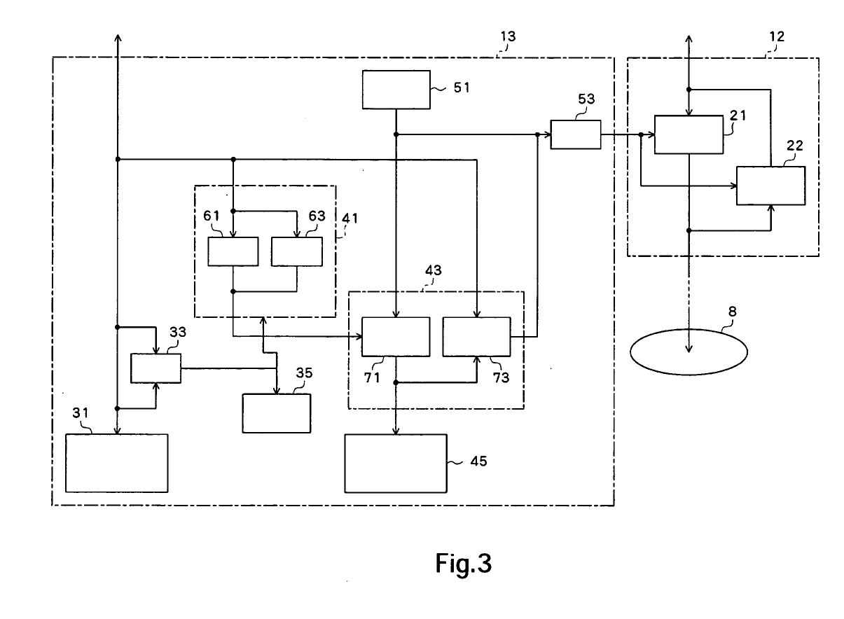

FIG. 3 is a block diagram illustrating, as an example, a configuration of the data encryption/decryption circuit 12 and the data-key management circuit 13 that are included in the MPU/HDC 1.

The data encryption/decryption circuit 12 includes a data encryption unit 21 and a data decryption unit 22. When data (write data) to be written to the magnetic disk 8 is inputted from the host side, the data encryption unit 21 encrypts the data by use of a data key inputted from the data-key management circuit 13, and then outputs the encrypted data to the magnetic disk 8 side. In addition, when data (read data) which has been read out from the magnetic disk 8 is inputted from the magnetic disk 8 side, the data decryption unit 22 decrypts the data by use of a data key inputted from the data-key management circuit 13, and then outputs the decrypted data to the host side.

This data key is key data used to encrypt/decrypt data by the data encryption/decryption circuit 12. Here, the private-key cryptography (symmetric key cryptography) is used. The private-key cryptography uses the same key to perform encryption and decryption. If the private-key cryptography is used, it is possible to quickly perform the encryption/decryption in comparison with the other kinds of cryptography (for example, the public-key cryptography). Therefore, the private-key cryptography is suitable for such use that the large amount of data is frequently written/read to/from, for example, the magnetic disk 8.

The data-key management circuit 13 includes an authentication information storage unit 31, a user authentication unit 33, an authentication information holding unit 35, a user key storage unit 41, a data key encryption/decryption unit 43, a data key storage unit 45, a data key generator 51, and a data-key input state holding unit 53.

The authentication information storage unit 31 stores password information (password information at the time of setting) that is used to authenticate a user who uses the data recording device 10. Password information at the time of setting, which is inputted from the host at the time of setting by the user, is stored in the authentication information storage unit 31. In addition, when the user is authenticated, the password information is read out by user authentication unit 33. Here, the password information is stored in the authentication information storage unit 31 with the password information being associated with user information including accounts so as to allow a plurality of users to use the data storage device 10. Incidentally, the password information stored in the authentication information storage unit 31 may also be encrypted or the like.

When the user is authenticated, the user authentication unit 33 compares the password information (password information at the time of authentication) inputted from the host with the password information at the time of setting read out from the authentication information storage unit 31. If both of the password information agree with each other, the user authentication unit 33 authenticates the user. After the user authentication unit 33 authenticates the user, the user authentication unit 33 outputs user information to the authentication information holding unit 35. If the authentication information holding unit 35 holds the user information inputted from the user authentication unit 33, the authentication information holding unit 35 permits operation of other configurations, and thereby generates an authentication state of the user. Incidentally, even if the password information stored in the authentication information storage unit 31 is encrypted or subjected to other processing, proper authentication of the user corresponding to the encryption suffices.

The user key storage unit 41 includes a storage area for storing encryption keys (here, private keys) of the plurality of users (in the figure, a first storage area 61 and a second storage area 63 are shown as examples). The user key storage unit 41 stores a user's private key that has been inputted from the host at the time of the user's authentication. In addition, when a data key is encrypted as described below, a data key encryption unit 71 of the data key encryption/decryption unit 43 reads out the user's private key. Incidentally, the private keys of the plurality of users, which are stored in the user key storage unit 41, may also be subjected to other encryption processing so that the tamper resistance is increased.

Here, the data key is encrypted/decrypted using the public key cryptography (asymmetric key cryptography) in which key data for encryption (private key) differs from that for decryption (decryption key). The public key cryptography uses a private key and a public key. In this embodiment, the private key is used as an encryption key, whereas the public key is used as a decryption key (and vice versa). If the public key cryptography is used, a user (administrator) of the data recording device can manage one key (in this case, the public key) because the encryption key differs from the decryption key. Accordingly, by storing the other key (in this case, the private key) in the user key storage unit 41, it becomes possible to encrypt the data key in the data recording device.

The data key encryption/decryption unit 43 includes the data key encryption unit 71 for encrypting a data key, and a data key decryption unit 73 for decrypting a data key.

The data key encryption unit 71 encrypts a data key created by the data key generator 51 by use of a user's private key, which has been read out from the user key storage unit 41, so as to create an encrypted data key. The data key encryption unit 71 then stores the created encrypted data key in the data key storage unit 45.

When a user's public key (decryption key) is inputted from the host, the data key decryption unit 73 reads out, from the data key storage unit 45, an encrypted data key that is encrypted by use of a private key corresponding to the public key, and then decrypts the encrypted data key by use of the public key. After that, the decrypted data key is output to the data-key input state holding unit 53, and is then inputted into the data encryption/decryption circuit 12.

The data key storage unit 45 stores a plurality of encrypted data keys, each of which is encrypted using a private key of each user. When a data key is encrypted, an encrypted data key inputted from the data key encryption unit 71 is stored in the data key storage unit 45. On the other hand, when a data key is decrypted, the data key decryption unit 73 reads out an encrypted data key from the data key storage unit 45. Because the data key is stored in the data key storage unit 45 in an encrypted state, the data key is configured to be tamper resistant.

The data key generator 51 generates a data key that is used to encrypt/decrypt data by the data encryption/decryption circuit 12. The data key is output to the data-key input state holding unit 53 so that the data-key input state holding unit 53 sets the data key for the data encryption/decryption circuit 12. In addition, the data key generator 51 also outputs the generated data key to the data key encryption unit 71 so that an encrypted data key is created. By locating the data key generator 51 inside the data recording device, it is possible to increase the tamper resistance of a generated data key.

When a decrypted data key is inputted from the data key decryption unit 73, the data-key input state holding unit 53 inputs the data key into the data encryption/decryption circuit 12, and holds the input state thereof. By buffering the data key (key data), the data-key input state holding unit 53 holds an input state of the data key for the data encryption/decryption circuit 12. By holding the input state of the data key, the data-key input state holding unit 53 can cause the data encryption/decryption circuit 12 to quickly encrypt/decrypt write data/read data. Accordingly,.it is suitable for such use that the large amount of data is frequently written/read to/from, for example, the magnetic disk 8. Incidentally, the data-key input state holding unit 53 may also be configured to be included in the data encryption/decryption circuit 12.

Next, specific operation of the data-key management circuit 13 will be described.

Processing of Storing a User Key

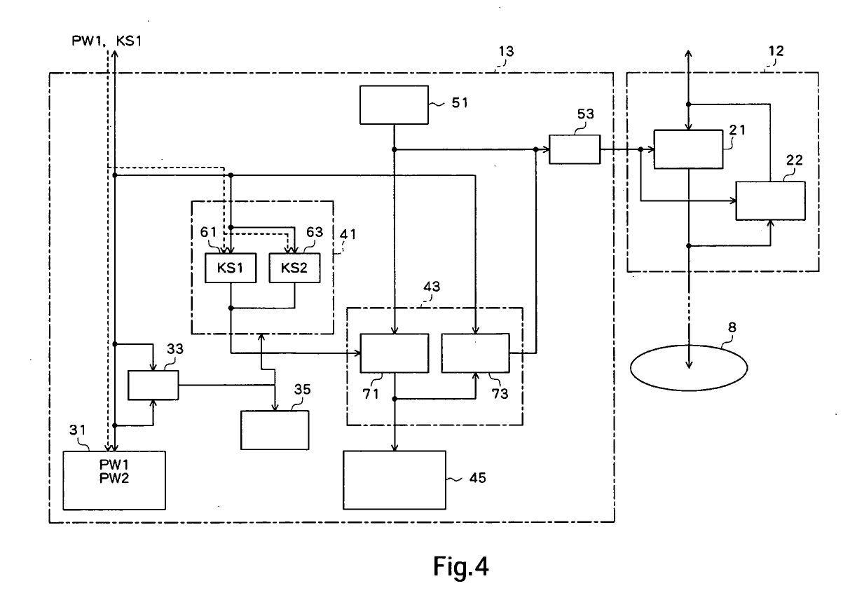

FIG. 4 is a diagram illustrating the operation in which the data-key management circuit 13 stores a user's private key. The operation of storing the user's private key is performed at the time of setting by a user. Here, on the assumptions that password information of a user 1 is PW1, and that a private key is KS1, at the time of setting by the user 1, when the password information PW1 and the private key KS1 are inputted from the host, the password information PW1 is stored in the authentication information storage unit 31, whereas the private key KS1 is stored in a first storage area 61 of the user key storage unit 41. In addition, on the assumptions that password information of a user 2 is PW2, and that a private key is KS2, at the time of setting by the user 2, the password information PW2 inputted from the host is stored in the authentication information storage unit 31, whereas the private key KS2 is stored in a second storage area 63 of the user key storage unit 41 in a like manner.

This figure shows an example in which the user key storage unit 41 has two storage areas of the first storage area 61 and the second storage area 63. However, the configuration of the user key storage unit 41 is not limited to this example. The user key storage unit 41 may also be configured to have three or more storage areas so that private keys of other users are stored. In addition, for example, if a private key stored in a storage area becomes unnecessary, it is also possible to overwrite the storage area with another private key.

Encryption Processing of a Data Key

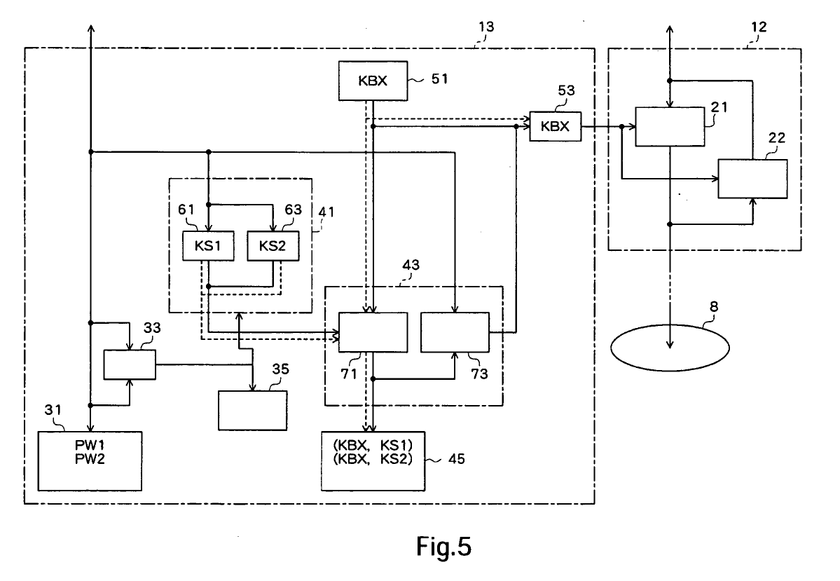

FIG. 5 is a diagram illustrating the operation in which the data-key management circuit 13 encrypts a data key. The operation of encrypting the data key is performed with a private key being stored in the user key storage unit 41. Here, on the assumption that a data key generated by the data key generator 51 is KBX, the data key generator 51 generates the data key KBX, and then outputs the data key KBX to the data-key input state holding unit 53 so that the data-key input state holding unit 53 sets the data key KBX for the data encryption/decryption circuit 12.

In addition, the data key generator 51 outputs the generated data key KBX to the data key encryption unit 71. In response to this, the data key encryption unit 71 reads out a private key KS1 of the user 1 and a private key KS2 of the user 2, which are stored in the user key storage unit 41. Then, the data key encryption unit 71 encrypts the data key KBX by use of these private keys KS1, KS2 to create encrypted data keys (KBX, KS1), (KBX, KS2), which are then stored in the data key storage unit 45. Incidentally, in this embodiment, one data key KBX is used for the data recording device. However, the number of data keys KBX is not limited to one. A plurality of data keys can also be provided so that each recording area (for example, each partition) corresponds to each of the data keys.

Thus, by including the data key storage unit 45 in the data-key management circuit 13, it is possible to hold the encrypted data key in the data recording device. In addition, because the encrypted data key is encrypted using the user's private key, third parties cannot use the encrypted data key that is stored in the data key storage unit 45. Incidentally, because the encrypted data key is encrypted using the user's private key, the encrypted data key can also be written to the magnetic disk 8. Moreover, because what is stored in the user key storage unit 41 is the user's private key, the encrypted data key cannot be decrypted using this private key.

In addition, because the data-key management circuit 13 includes the user key storage unit 41, it is not necessary to input a private key every time a data key is encrypted. Moreover, by storing a plurality of private keys in the user key storage unit 41, the data key encryption unit 71 can create an encrypted data key on a user basis by use of each of the private keys. To be more specific, while a certain user (for example, the user 1) is authenticated, it is possible to use a private key of another user (for example, the user 2) to create an encrypted data key of the user 2 in the data recording device without outputting this private key to the outside.

Decryption Processing of a Data Key

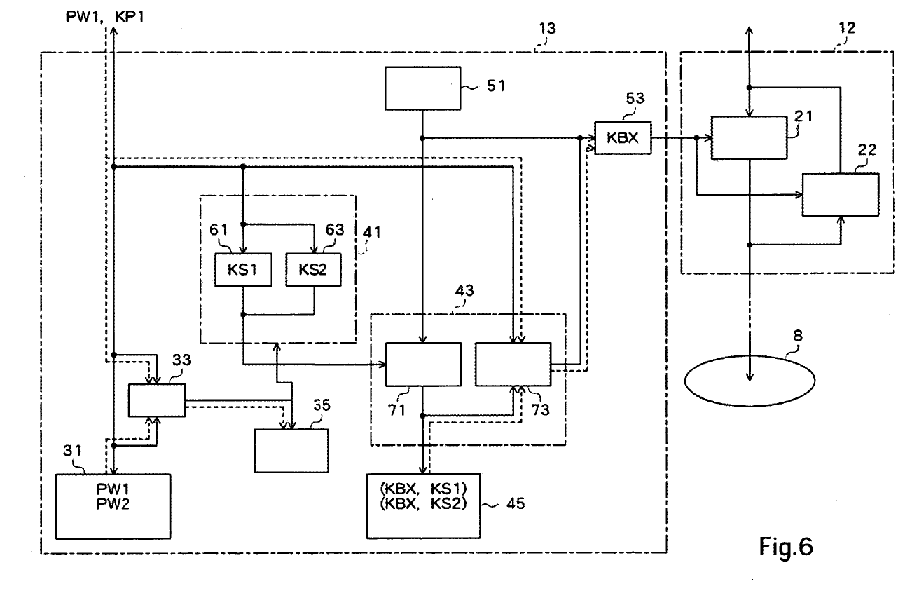

FIG. 6 is a diagram illustrating the operation in which the data-key management circuit 13 decrypts a data key. The operation of decrypting the data key is performed at the time of authenticating a user. In addition, the decryption processing is performed with an encrypted data key being stored in the data key storage unit 45. Here, on the assumption that a public key of the user 1 is KP1, at the time of authenticating the user 1, when password information PW1 and a public key KP1 are inputted from the host, the password information PW1 is inputted into the user authentication unit 33, whereas the public key KP1 is inputted into the data key decryption unit 73.

The user authentication unit 33 compares the password information (password information at the time of authentication) PW1 inputted from the host with password information (password information at the time of setting) PW1 stored in the authentication information storage unit 31. If both of the password information agree with each other, the user 1 is authenticated. On the completion of the authentication of the user 1, the user authentication unit 33 outputs user information of the user 1 to the authentication information holding unit 35. The authentication information holding unit 35 generates an authentication state of the user 1.

On the completion of the authentication of the user 1, the data key decryption unit 73 reads out the encrypted data key (KBX, KS1) that is encrypted by use of the private key KS1 corresponding to the public key KP1 inputted from the host. Then, the data key decryption unit 73 decrypts the encrypted data key (KBX, KS1) by use of the public key KP1 to acquire the data key KBX, and then outputs the decrypted data key KBX to the data-key input state holding unit 53. In response to this, the data-key input state holding unit 53 inputs the data key KBX into the data encryption/decryption circuit 12. This makes it possible to encrypt/decrypt write data/read data in the data encryption/decryption circuit 12 (data encryption/decryption step). In this case, it may also be so configured that in order to validate the public key KP1 inputted from the host, known information is concatenated with the encrypted data key (KBX, KS1), which is stored in the data key storage unit 45, before the encrypted data key (KBX, KS1) is encrypted, and that a check is made as to whether or not the known information is correctly decrypted at the time of decrypting the data key KBX.

As described above, the encrypted data keys, each of which is encrypted using a private key corresponding to each user, are stored in the data key storage unit 45. When a public key corresponding to each user is inputted, the data key decryption unit 73 decrypts an encrypted data key that is encrypted by use of a private key corresponding to this public key. As a result, it is possible to easily manage the data key on a user basis. To be more specific, each user can encrypt data by inputting a user's own public key. Moreover, as another configuration, in order not to accept an erroneous public key at the time of user authentication, on the assumption that a public key of the user 1 is KP1, encrypted password information PW1 and a public key KP1 are inputted. Here, the encrypted password information PW1 is acquired by encrypting, by use of the public key KP1, password information PW1 that is inputted from the host at the time of the authentication of the user 1. After that, in the data-key management circuit 13, the encrypted password information PW1 is decrypted using a corresponding private key KS1 of the user 1, which is stored in the user key storage unit 41. Then, the password information PW1 is authenticated. At this time, information inputted into the information storage device 10, and key information, at the time of user setting differ from those at the time of authentication.

Encryption Processing of a Changed Data Key

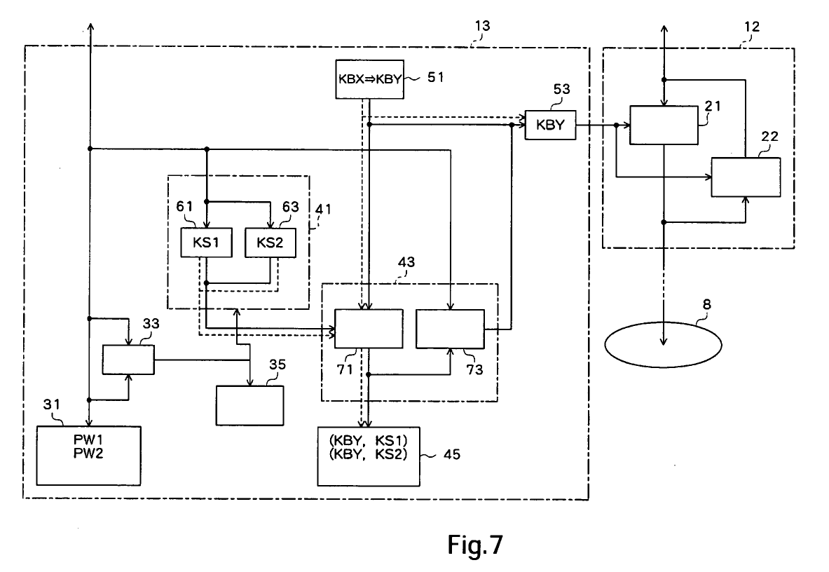

FIG. 7 is a diagram illustrating the operation in which the data-key management circuit 13 encrypts a changed data key. The operation of encrypting the changed data key is also performed with a private key being stored in the user key storage unit 41. In addition, the above-described operation may also be performed with the user authentication having been completed. Here, when the data key generator 51 changes a data key to be applied to the data encryption/decryption circuit 12 from KBX to KBY, the data key generator 51 outputs the newly created data key KBY to the data-key input state holding unit 53, and instructs the data encryption/decryption circuit 12 to set the data key KBY as new key data used for operation.

In addition, the data key generator 51 outputs the newly generated data key KBY to the data key encryption unit 71. In response to this, the data key encryption unit 71 reads out a private key KS1 of the user 1 and a private key KS2 of the user 2, which are stored in the user key storage unit 41. Then, the data key encryption unit 71 encrypts the data key KBY by use of these private keys KS1, KS2 to newly create encrypted data keys (KBY, KS1), (KBY, KS2), which are then stored in the data key storage unit 45.

Thus, if a data key to be applied to the data encryption/decryption circuit 12 is changed, by creating again a new encrypted data key using a plurality of private keys stored in the user key storage unit 41, it is possible for each user to encrypt data in the same manner as that before the change, even if the data key is changed. To be more specific, even if each user is not informed that a data key has been changed, if the user inputs a user's own public key in the same manner as before, the user can decrypt an encrypted data key to acquire a data key. This prevents the data recording device from being disabled.

In addition, by storing a plurality of secret keys in the user key storage unit 41, the data key encryption unit 71 can create a new encrypted data key by use of the stored private keys without taking trouble to input an encryption key of each user again.

What is claimed is:

1. A data recording device comprising:
a data encryption/decryption unit for, when a data key is inputted, performing at least one of encryption of data to be written to a recording medium, and decryption of data read out from the recording medium; and
a data key decryption unit for, when a decryption key corresponding to one of a plurality of encryption keys is inputted by use of the decryption key, an encrypted data key that is encrypted by use of said one of the plurality of encryption keys, said encrypted data key being one of a plurality of encrypted data keys that have been created by encrypting the data key by use of the plurality of encryption keys respectively, each of which is specific to each user, and then for outputting the data key to the data encryption/decryption unit.

2. The data recording device according to claim 1, further comprising a data key storage unit for storing the plurality of encrypted data keys.

3. The data recording device according to claim 1, further comprising a data key encryption unit for creating the plurality of encrypted data keys by encrypting the data key by use of the plurality of encryption keys respectively, each of which is specific to each user.

4. The data recording device according to claim 3, further comprising a user key storage unit for storing the plurality of encryption keys, wherein:
said data key encryption unit creates the plurality of encrypted data keys by encrypting the data key by use of the plurality of encryption keys respectively, said plurality of encryption keys being stored in the user key storage unit.

5. The data recording device according to claim 3, further comprising a user key storage unit for storing the plurality of encryption keys, wherein:
if the data key applied to the data encryption/decryption unit is changed to a new data key, said data key encryption unit newly creates a plurality of encrypted data key by encrypting the new data key by use of the plurality of encryption keys respectively, said plurality of encryption keys being stored in the user key storage unit.

6. The data recording device according to claim 1, further comprising a data-key input state holding unit for holding an input state of the data key for the data encryption/decryption circuit.

7. A data management method comprising:
a data key encryption step for creating a plurality of encrypted data keys by encrypting a data key by use of a plurality of encryption keys respectively, each of which is specific to each user, said data key being used to perform at least one of encryption of data to be written to a recording medium, and decryption of data read out from the recording medium;
a data key decryption step for, when a decryption key corresponding to one of the plurality of encryption keys is inputted by use of the decryption key, the encrypted data key that is encrypted the data key by use of said one of the plurality of encryption keys, said encrypted data key being one of the plurality of encrypted data keys; and
data encryption/decryption step for, on the basis of the data key that is decrypted, performing at least one of encryption of data to be written to the recording medium, and decryption of data read out from the recording medium.
